(19) United States
(12) Patent Application Publication
(10) Pub. No.: US 2007/0268903 A1
(43) Pub. Date: Nov. 22, 2007

(54) System and Method for Assigning Packets to Output Queues

(75) Inventor: Yuhikiro Nakagawa, Cupertino, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/419,713

(22) Filed: May 22, 2006

(51) Int. Cl. H04L 12/56

(52) U.S. Cl. 370/392

(57) ABSTRACT

In particular embodiments of the present invention, a method for assigning packets to output queues of a switch is provided. In a particular embodiment, a method for assigning packets to output queues of a switch includes receiving a packet at an input port of a switch, the packet associated with at least one flow identifier, the flow identifier identifying a flow with which the packet is associated. The method also includes processing the at least one flow identifier to generate a flow value. The method further includes, based at least on the flow value, assigning the packet to an output queue associated with an output port of the switch.

### TECHNICAL FIELD OF THE INVENTION

This invention relates generally to communication systems and more particularly to a system and method for assigning packets to output queues.

### BACKGROUND OF THE INVENTION

High-speed serial interconnects have become more common in communications environments, and, as a result, the role that switches play in these environments has become more important. Traditional switches do not provide the scalability and switching speed typically needed to support these interconnects.

### SUMMARY OF THE INVENTION

Particular embodiments of the present invention may reduce or eliminate disadvantages and problems traditionally associated with switching packets.

In particular embodiments of the present invention, a method for assigning packets to output queues of a switch is provided. In a particular embodiment, a method for assigning packets to output queues of a switch includes receiving a packet at an input port of a switch, the packet associated with at least one flow identifier, the flow identifier identifying a flow with which the packet is associated. The method also includes processing the at least one flow identifier to generate a flow value. The method further includes, based at least on the flow value, assigning the packet to an output queue associated with an output port of the switch.

Particular embodiments of the present invention provide one or more advantages. Particular embodiments increase the fairness and efficiency of queuing at an output port of a switch by queuing based on a number of characteristics relating to the traffic flow being processed and by more accurately mapping different types of packets to separate output queues. For example, when the switch implements link aggregation, particular embodiments map multiple physical input ports to one logical port and process the flow from these input ports as one flow in an output port queue. As another example, when the switch participates in partitioning (e.g., virtual LAN partitioning), particular embodiments map separate partition flows (e.g., traffic in different VLANs) to separate queues. As yet another example, particular embodiments may use multiple packet header fields to assign a packet to an output queue. These fields may include quality of service (QoS) levels and/or packet addressing information. Another advantage of particular embodiments is the reconfigurability of output queues, providing network operators increased flexibility in assigning and reassigning transmission preferences to particular types of packets. Certain embodiments provide all, some, or none of these technical advantages, and certain embodiments provide one or more other technical advantages readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates an example system area network;

FIG. 2 illustrates an example switch of a system area network;

FIG. 3 illustrates an example switch core of a switch;

FIG. 4 illustrates an example stream memory of a switch core logically divided into blocks;

FIGS. 5A and 5B illustrate example output queue structures;

FIG. 6 is a block diagram illustrating example logic for mapping physical input ports to a logical input port;

FIG. 7 is a block diagram illustrating example logic for assigning packets to output queues; and

FIG. 8 illustrates an example output queue structure of an output port module in a switch.

### DESCRIPTION OF EXAMPLE EMBODIMENTS

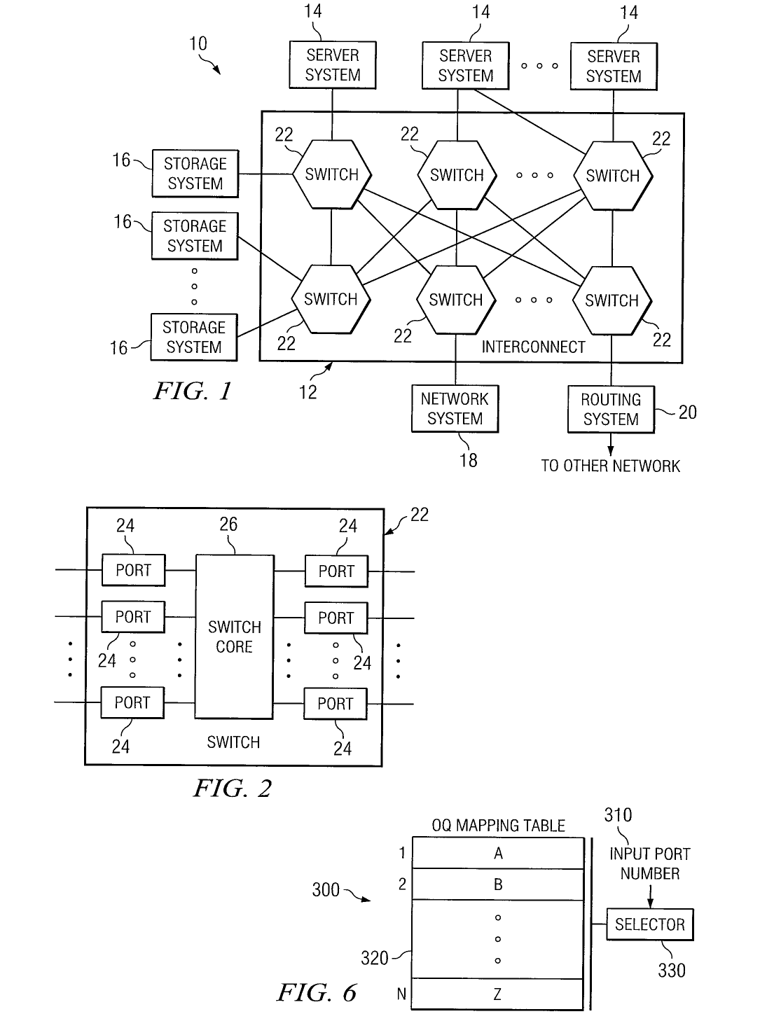

FIG. 1 illustrates an example system area network 10 that includes a serial or other interconnect 12 supporting communication among one or more server systems 14; one or more storage systems 16; one or more network systems 18; and one or more routing systems 20 coupling interconnect 12 to one or more other networks, which include one or more local area networks (LANs), wide area networks (WANs), or other networks. Server systems 14 each include one or more central processing units (CPUs) and one or more memory units. Storage systems 16 each include one or more channel adaptors, one or more disk adaptors, and one or more CPU modules. Interconnect 12 includes one or more switches 22, which, in particular embodiments, include Ethernet switches, as described more fully below. The components of system area network 10 are coupled to each other using one or more links, each of which includes one or more computer buses, local area networks (LANs), metropolitan area networks (MANs), wide area networks (WANs), portions of the Internet, or other wireline, optical, wireless, or other links. Although system area network 10 is described and illustrated as including particular components coupled to each other in a particular configuration, the present invention contemplates any suitable system area network including any suitable components coupled to each other in any suitable configuration.

FIG. 2 illustrates an example switch 22 of system area network 10. Switch 22 includes multiple ports 24 and a switch core 26. Ports 24 are each coupled to switch core 26 and a component of system area network 10 (such as a server system 14, a storage system 16, a network system 18, a routing system 20, or another switch 22). A first port 24 receives a packet from a first component of system area network 10 and communicates the packet to switch core 26 for switching to a second port 24, which communicates the packet to a second component of system area network 10. Reference to a packet can include a packet, datagram, frame, or other unit of data, where appropriate. Switch core 26 receives a packet from a first port 24 and switches the packet to one or more second ports 24, as described more fully below. In particular embodiments, switch 22 includes an Ethernet switch. In particular embodiments, switch 22 can switch packets at or near wire speed.

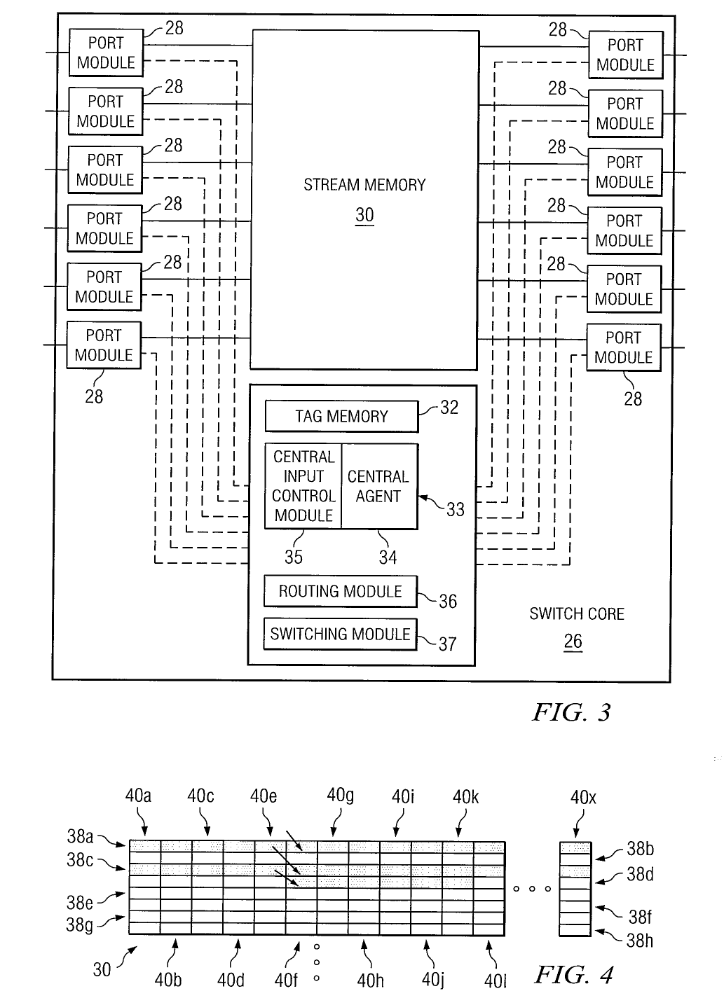

FIG. 3 illustrates an example switch core 26 of switch 22. Switch core 26 includes twelve port modules 28, stream memory 30, tag memory 32, input control and central agent (ICCA) 33, routing module 36, and switching module 37. The components of switch core 26 are coupled to each other using buses or other links. In particular embodiments, switch core 26 is embodied in a single IC. In a default mode of switch core 26, a packet received by switch core 26 from a first component of system area network 10 can be communicated from switch core 26 to one or more second components of system area network 10 before switch core 26 receives the entire packet. In particular embodiments, cut-through forwarding provides one or more advantages (such as reduced latency, reduced memory requirements, and increased throughput) over store-and-forward techniques. Switch core 26 can be configured for different applications. As an example and not by way of limitation, switch core 26 can be configured for an Ethernet switch 22 (which includes a ten-gigabit Ethernet switch 22 or an Ethernet switch 22 in particular embodiments); an INFINIBAND switch 22; a 3GIO switch 22; a HYPERTRANSPORT switch 22; a RAPID IO switch 22; a proprietary backplane switch 22 for storage systems 16, network systems 18, or both; or other switch 22.

A port module 28 provides an interface between switch core 26 and a port 24 of switch 22. Port module 28 is communicatively coupled to port 24, stream memory 30, tag memory 32, ICCA 33, routing table 36, and switching module 37. In particular embodiments, port module 28 includes both input logic (which is used for receiving a packet from a component of system area network 10 and writing the packet to stream memory 30) and output logic (which is used for reading a packet from stream memory 30 and communicating the packet to a component of system area network 10). As an alternative, in particular embodiments, port module 28 includes only input logic or only output logic. Reference to a port module 28 can include a port module 28 that includes input logic, output logic, or both, where appropriate. Port module 28 can also include an input buffer for inbound flow control. In an Ethernet switch 22, a pause function can be used for inbound flow control, which can take time to be effective. The input buffer of port module 28 can be used for temporary storage of a packet that is sent before the pause function stops incoming packets. Because the input buffer would be unnecessary if credits are exported for inbound flow control, as would be the case in an INFINIBAND switch 22, the input buffer is optional. In particular embodiments, the link coupling port module 28 to stream memory 30 includes two links: one for write operations (which include operations of switch core 26 in which data is written from a port module 28 to stream memory 30) and one for read operations (which include operations of switch core 26 in which data is read from stream memory 30 to a port module 28). Each of these links can carry thirty-six bits, making the data path between port module 28 and stream memory 30 thirty-six bits wide in both directions.

A packet received by a first port module 28 from a first component of system area network 10 is written to stream memory 30 from first port module 28 and later read from stream memory 30 to one or more second port modules 28 for communication from second port modules 28 to one or more second components of system area network 10. Reference to a packet being received by or communicated from a port module 28 can include the entire packet being received by or communicated from port module 28 or only a portion of the packet being received by or communicated from port module 28, where appropriate. Similarly, reference to a packet being written to or read from stream memory 30 can include the entire packet being written to or read from stream memory 30 or only a portion of the packet being written to or read from stream memory 30, where appropriate. Any port module 28 that includes input logic (an “input port module”) can write to stream memory 30, and any port module 28 that includes output logic (an “output port module”) can read from stream memory 30. In particular embodiments, a port module 28 may include both input logic and output logic and may thus be both an input port module and an output port module. In particular embodiments, the sharing of stream memory 30 by port modules 28 eliminates head-of-line blocking (thereby increasing the throughput of switch core 26), reduces memory requirements associated with switch core 26, and enables switch core 26 to more efficiently handle changes in load conditions at port modules 28.

Stream memory 30 of switch core 26 is logically divided into blocks 38, which are further divided into words 40, as illustrated in FIG. 4. A row represents a block 38, and the intersection of the row with a column represents a word 40 of block 38. In particular embodiments, stream memory 30 is divided into 1536 blocks 38, each block 38 includes twenty-four words 40, and a word 40 includes seventy-two bits. Although stream memory 30 is described and illustrated as being divided into a particular number of blocks 38 that are divided into a particular number of words 40 including a particular number of bits, the present invention contemplates stream memory 30 being divided into any suitable number of blocks 38 that are divided into any suitable number of words 40 including any suitable number of bits. Packet size can vary from packet to packet. A packet that includes as many bits as or fewer bits than a block 38 can be written to one block 38, and a packet that includes more bits than a block 38 can be written to more than one block 38, which need not be contiguous with each other.

When writing to or reading from a block 38, a port module 28 can start at any word 40 of block 38 and write to or read from words 40 of block 38 sequentially. Port module 28 can also wrap around to a first word 40 of block 38 as it writes to or reads from block 38. A block 38 has an address that can be used to identify block 38 in a write operation or a read operation, and an offset can be used to identify a word 40 of block 38 in a write operation or a read operation. As an example, consider a packet that is 4176 bits long. The packet has been written to fifty-eight words 40, starting at word 40f of block 38a and continuing to word 40k of block 38d, excluding block 38b. In the write operation, word 40f of block 38a is identified by a first address and a first offset, word 40f of block 38c is identified by a second address and a second offset, and word 40f of block 38d is identified by a third address and a third offset. The packet can also be read from stream memory 30 starting at word 40f of block 38a and continuing to word 40k of block 38d, excluding block 38b. In the read operation, word 40f of block 38a can be identified by the first address and the first offset, word 40f of block 38c can be identified by the second address and the second offset, and word 40f of block 38d can be identified by the third address and the third offset.

Tag memory 32 includes multiple linked lists that can each be used, by, for example, central input control module 35, to determine a next block 38 to which first port module 28 may write and, by, for example, second port modules 28, to determine a next block 38 from which second port modules 28 may read. Tag memory 32 also includes a linked list that can be used by central agent 34 to determine a next block 38 that can be made available to a port module 28 for a write operation from port module 28 to stream memory 30, as described more fully below. Tag memory 32 includes multiple entries, at least some of which each correspond to a block 38 of stream memory 30. Each block 38 of stream memory 30 has a corresponding entry in tag memory 32. An entry in tag memory 32 can include a pointer to another entry in tag memory 32, resulting in a linked list.

Entries in tag memory 32 corresponding to blocks 38 that are available to a port module 28 for write operations from port module 28 to stream memory 30 can be linked together such that a next block 38 to which a port module 28 may write can be determined using the linked entries. When a block 38 is made available to a port module 28 for write operations from port module 28 to stream memory 30, an entry in tag memory 32 corresponding to block 38 can be added to the linked list being used to determine a next block 38 to which port module 28 may write.

A linked list in tag memory 32 being used to determine a next block 38 to which a first port module 28 may write can also be used by one or more second port modules 28 to determine a next block 38 from which to read. As an example, consider the linked list described above. A first portion of a packet has been written from first port module 28 to first block 38, a second portion of the packet has been written from first port module 28 to second block 38, and a third and final portion of the packet has been written from first port module 28 to third block 38. An end mark has also been written to third block 38 to indicate that a final portion of the packet has been written to third block 38. A second port module 28 reads from first block 38 and, while second port module 28 is reading from first block 38, uses the pointer in the first entry to determine a next block 38 from which to read. The pointer refers second port module 28 to second block 38, and, when second port module 28 has finished reading from first block 38, second port module 28 reads from second block 38. While second port module 28 is reading from second block 38, second port module 28 uses the pointer in the second entry to determine a next block 38 from which to read. The pointer refers second port module 28 to third block 38, and, when second port module 28 has finished reading from second block 38, second port module 28 reads from third block 38. Second port module 28 reads from third block 38 and, using the end mark in third block 38, determines that a final portion of the packet has been written to third block 38. While a linked list in tag memory 32 cannot be used by more than one first port module 28 to determine a next block 38 to which to write, the linked list can be used by one or more second port modules 28 to determine a next block 38 from which to read.

Different packets can have different destinations, and the order in which packets make their way through stream memory 30 need not be first in, first out (FIFO). As an example, consider a first packet received and written to one or more first blocks 38 before a second packet is received and written to one or more second blocks 38. The second packet could be read from stream memory 30 before the first packet, and second blocks 38 could become available for other write operations before first blocks 38. In particular embodiments, a block 38 of stream memory 30 to which a packet has been written can be made available to a port module 28 for a write operation from port module 28 to block 38 immediately after the packet has been read from block 38 by all port modules 28 that are designated port modules 28 of the packet. A designated port module 28 of a packet includes a port module 28 coupled to a component of system area network 10, downstream from switch core 26, that is a final or intermediate destination of the packet.

Using credits to manage write operations may offer particular advantages. For example, using credits can facilitate cut-through forwarding by switch core 26, which reduces latency, increases throughput, and reduces memory requirements associated with switch core 26. Using credits to manage write operations can also eliminate head-of-line blocking and provide greater flexibility in the distribution of memory resources among port modules 28 in response to changing load conditions at port modules 28. A credit corresponds to a block 38 of stream memory 30 and can be used by a port module 28 to write to block 38. A credit can be allocated to a port module 28 from a pool of credits, which is managed by central agent 34. Reference to a credit being allocated to a port module 28 includes a block 38 corresponding to the credit being made available to port module 28 for a write operation from port module 28 to block 38, and vice versa.

A credit in the pool of credits can be allocated to any port module 28 and need not be allocated to any particular port module 28. A port module 28 can use only a credit that is available to port module 28 and cannot use a credit that is available to another port module 28 or that is in the pool of credits. A credit is available to port module 28 if the credit has been allocated to port module 28 and port module 28 has not yet used the credit. A credit that has been allocated to port module 28 is available to port module 28 until port module 28 uses the credit. A credit cannot be allocated to more than one port module 28 at a time, and a credit cannot be available to more than one port module 28 at the same time. In particular embodiments, when a first port module 28 uses a credit to write a packet to a block 38 corresponding to the credit, the credit is returned to the pool of credits immediately after all designated port modules 28 of the packet have read the packet from block 38.

ICCA 33 includes central agent 34 and central input control module 35. Central agent 34 is operable to allocate credits to port modules 28 from the pool of credits. As an example, central agent 34 can make an initial allocation of a predetermined number of credits to a port module 28. Central agent 34 can make this initial allocation of credits to port module 28, for example, at the startup of switch core 26 or in response to switch core 26 being reset. As another example, central agent 34 can allocate a credit to a port module 28 to replace another credit that port module 28 has used. In particular embodiments, when port module 28 uses a first credit, port module 28 notifies central agent 34 that port module 28 has used the first credit, and, in response to port module 28 notifying central agent 34 that port module 28 has used the first credit, central agent 34 allocates a second credit to port module 28 to replace the first credit, if, for example, the number of blocks 38 that are being used by port module 28 does not meet or exceed an applicable limit. In particular embodiments, central agent 34 can store port-allocated credits in central input control module 35 of ICCA 33 until requested by port modules 28 after the receipt of a packet.

It should be noted that reference to a block 38 that is being used by a port module 28 includes a block 38 to which a packet has been written from port module 28 and from which all designated port modules 28 of the packet have not read the packet. By replacing, up to an applicable limit, credits used by port module 28, the number of credits available to port module 28 can be kept relatively constant and, if the load conditions at port module 28 increase, more blocks 38 can be supplied to port module 28 in response to the increase in load conditions at port module 28. A limit may be applied in certain circumstances to the number of blocks used by port module 28, which may prevent port module 28 from using too many blocks 38 and thereby use up too many shared memory resources. The limit can be controlled dynamically based on the number of credits in the pool of credits. If the number of credits in the pool of credits decreases, the limit can also decrease. The calculation of the limit and the process according to which credits are allocated to port module 28 can take place out of the critical path of packets through switch core 26, which increases the switching speed of switch core 26.

A linked list in tag memory 32 can be used by central agent 34 to determine a next credit that can be allocated to a port module 28. The elements of the linked list can include entries in tag memory 32 corresponding to blocks 38 that in turn correspond to credits in the pool of credits. As an example, consider four credits in the pool of credits. A first credit corresponds to a first block 38, a second credit corresponds to a second block 38, a third credit corresponds to a third block 38, and a fourth credit corresponds to a fourth block 38. A first entry in tag memory 32 corresponding to first block 38 includes a pointer to second block 38, a second entry in tag memory 32 corresponding to second block 38 includes a pointer to third block 38, and a third entry in tag memory 32 corresponding to third block 38 includes a pointer to fourth block 38. Central agent 34 allocates the first credit to a port module 28 and, while central agent 34 is allocating the first credit to a port module 28, uses the pointer in the first entry to determine a next credit to allocate to a port module 28. The pointer refers central agent 34 to second block 38, and, when central agent 34 has finished allocating the first credit to a port module 28, central agent 34 allocates the second credit to a port module 28. While central agent 34 is allocating the second credit to a port module 28, central agent 34 uses the pointer in the second entry to determine a next credit to allocate to a port module 28. The pointer refers central agent 34 to third block 38, and, when central agent 34 has finished allocating the second credit to a port module 28, central agent allocates the third credit to a port module 28. While central agent 34 is allocating the third credit to a port module 28, central agent 34 uses the pointer in the third entry to determine a next credit to allocate to a port module 28. The pointer refers central agent 34 to fourth block 38, and, when central agent 34 has finished allocating the third credit to a port module 28, central agent allocates the fourth credit to a port module 28.

When a credit corresponding to a block 38 is returned to the pool of credits, an entry in tag memory 32 corresponding to block 38 can be added to the end of the linked list that central agent 34 is using to determine a next credit to allocate to a port module 28. As an example, consider the linked list described above. If the fourth entry is the last element of the linked list, when a fifth credit corresponding to a fifth block 38 is added to the pool of credits, the fourth entry can be modified to include a pointer to a fifth entry in tag memory 32 corresponding to fifth block 38. Because entries in tag memory 32 each correspond to a block 38 of stream memory 30, a pointer that points to a block 38 also points to an entry in tag memory 32.

When a port module 28 receives an incoming packet, port module 28 determines whether enough credits are available to port module 28 to write the packet to stream memory 30. Port module 28 may do so, for example, by reading a counter at central agent 34 indicating the number of credits available to the port module 28 to write. Alternatively, port module 28 may receive this information automatically from central agent 34. In particular embodiments, if enough credits are available to port module 28 to write the packet to stream memory 30, port module 28 can write the packet to stream memory 30 using one or more credits. In particular embodiments, if enough credits are not available to port module 28 to write the packet to stream memory 30, port module 28 can write the packet to an input buffer and later, when enough credits are available to port module 28 to write the packet to stream memory 30, write the packet to stream memory 30 using one or more credits. As an alternative to port module 28 writing the packet to an input buffer, port module 28 can drop the packet. In particular embodiments, if enough credits are available to port module 28 to write only a portion of the packet to stream memory 30, port module 28 can write to stream memory 30 the portion of the packet that can be written to stream memory 30 using one or more credits and write one or more other portions of the packet to an input buffer. Later, when enough credits are available to port module 28 to write one or more of the other portions of the packet to stream memory 30, port module 28 can write one or more of the other portions of the packet to stream memory 30 using one or more credits. In particular embodiments, delayed cut-through forwarding, like cut-through forwarding, provides one or more advantages (such as reduced latency, reduced memory requirements, and increased throughput) over store-and-forward techniques. Reference to a port module 28 determining whether enough credits are available to port module 28 to write a packet to stream memory 30 includes port module 28 determining whether enough credits are available to port module 28 to write the entire packet to stream memory 30, write only a received portion of the packet to stream memory 30, or write at least one portion of the packet to stream memory 30, where appropriate.

In particular embodiments, the length of an incoming packet cannot be known until the entire packet has been received. In these embodiments, a maximum transmission unit (according to an applicable set of standards) can be used to determine whether enough credits are available to a port module 28 to write an incoming packet that has been received by port module 28 to stream memory 30. According to a set of standards published by the Institute of Electrical and Electronics Engineers (IEEE), the maximum transmission unit (MTU) of an Ethernet frame is 1500 bytes. According to a de facto set of standards, the MTU of an Ethernet frame is nine thousand bytes. As an example and not by way of limitation, consider a port module 28 that has received only a portion of an incoming packet. Port module 28 uses an MTU (according to an applicable set of standards) to determine whether enough credits are available to port module 28 to write the entire packet to stream memory 30. Port module 28 can make this determination by comparing the MTU with the number of credits available to port module 28. If enough credits are available to port module 28 to write the entire packet to stream memory 30, port module 28 can write the received portion of the packet to stream memory 30 using one or more credits and write one or more other portions of the packet to stream memory 30 using one or more credits when port module 28 receives the one or more other portions of the packet.

As described above, central agent 34 can monitor the number of credits available to port module 28 using a counter and provide this information to port module 28 automatically or after port module 28 requests the information. When central agent 34 allocates a credit to port module 28, central agent 34 increments the counter by an amount, and, when port module 28 notifies central agent 34 that port module 28 has used a credit, central agent 34 decrements the counter by an amount. The current value of the counter reflects the current number of credits available to port module 28, and central agent 34 can use the counter to determine whether to allocate one or more credits to port module 28. Central agent 34 can also monitor the number of blocks 38 that are being used by port module 28 using a second counter. When port module 28 notifies central agent 34 that port module 28 has written to a block 38, central agent increments the second counter by an amount and, when a block 38 to which port module 28 has written is released and a credit corresponding to block 38 is returned to the pool of credits, central agent decrements the second counter by an amount. Additionally or alternatively, central input control module 35 may also monitor the number of credits available to port modules 28 using its own counter(s).

The number of credits that are available to a port module 28 can be kept constant, and the number of blocks 38 that are being used by port module 28 can be limited. The limit can be changed in response to changes in load conditions at port module 28, one or more other port module 28, or both. In particular embodiments, the number of blocks 38 that are being used by a port module 28 is limited according to a dynamic threshold that is a function of the number of credits in the pool of credits. An active port module 28, in particular embodiments, includes a port module 28 that is using one or more blocks 38. Reference to a port module 28 that is using a block 38 includes a port module 28 that has written at least one packet to stream memory 30 that has not been read from stream memory 30 to all designated port modules 28 of the packet. A dynamic threshold can include a fraction of the number of credits in the pool of credits calculated using the following formula, in which α equals the number of port modules 28 that are active and ρ is a parameter:

$$\frac{ρ}{1 + ( ρ \times α )}$$

A number of credits in the pool of credits can be reserved to prevent central agent 34 from allocating a credit to a port module 28 if the number of blocks 38 that are each being used by a port module 28 exceeds an applicable limit, which can include the dynamic threshold described above. Reserving one or more credits in the pool of credits can provide a cushion during a transient period associated with a change in the number of port modules 28 that are active. The fraction of credits that are reserved is calculated using the following formula, in which α equals the number of active port modules 28 and ρ is a parameter:

$$\frac{1}{1 + ( ρ \times α )}$$

According to the above formulas, if one port module 28 is active and ρ is two, central agent 34 reserves one third of the credits and may allocate up to two thirds of the credits to port module 28; if two port modules 28 are active and ρ is one, central agent 34 reserves one third of the credits and may allocate up to one third of the credits to each port module 28 that is active; and if twelve port modules 28 are active and ρ is 0.5, central agent 34 reserves two fourteenths of the credits and may allocate up to one fourteenth of the credits to each port module 28 that is active. Although a particular limit is described as being applied to the number of blocks 38 that are being used by a port module 28, the present invention contemplates any suitable limit being applied to the number of blocks 38 that are being used by a port module 28.

In particular embodiments, central input control module 35 of ICCA 33 stores the credits allocated to particular port modules 28 by central agent 34 and can manage port-allocated credits using a linked list. Central input control module 35 can forward port-allocated credits to a particular, enabled port module 28 after the port module 28 requests a credit from central input control module 35. In particular embodiments, port-allocated credits are forwarded by central input control module 35 to enabled port modules 38 through switching module 37. When a port is disabled, central input control module 35 and switching module 37 may work together to collect and release the credits allocated to the disabled port. Although the illustrated embodiment includes central input control module 35 in ICCA 33, in alternative embodiments, central input control module 35 may reside in any suitable location, such as, for example, in central agent 34 or in port modules 28 themselves.

When a first port module 28 associated with an enabled port writes a packet to stream memory 30, first port module 28 can communicate to routing module 36 through switching module 37 information from the header of the packet (such as one or more destination addresses) that routing module 36 can use to identify one or more second port modules 28 that are designated port modules 28 of the packet. First port module 28 can also communicate to routing module 36 an address of a first block 38 to which the packet has been written and an offset that together can be used by second port modules 28 to read the packet from stream memory 30. The combination of this address and offset (or any other information used to identify the location at which the contents of a packet have been stored) will be referred to herein as a “pointer.” Routing module 36 can identify second port modules 28 using one or more routing tables and the information from the header of the packet and, after identifying second port modules 28, communicate the pointer to the first block 38 to each second port module 28, which second port module 28 can add to an output queue, as described more fully below. In particular embodiments, routing module 36 can communicate information to second port modules 28 through ICCA 33.

In particular embodiments, switching module 37 is coupled between port modules 28 and both routing module 36 and ICCA 33 to facilitate the communication of information between port modules 28 and ICCA 33 or routing module 36 when a port is enabled. When a port is disabled, switching module 37 is operable to facilitate the collection and release of port-allocated credits associated with the disabled port. It should be noted that, although a single switching module 37 is illustrated, switching module 37 may represent any suitable number of switching modules. In addition, switching module 37 may be shared by any suitable number of port modules 28. Furthermore, the functionality of switching module 37 may be incorporated in one or more of the other components of the switch.

An output port module 28 can include one or more output queues that are used to queue pointers for packets that have been written to stream memory 30 and that are to be communicated from switch core 26 through the associated port module 28. When a packet is written to stream memory 30, routing module 36 may identify designated port modules, and a pointer associated with the packet may be added to an output queue of each port module 28 from which the packet is to be communicated. As described further below in conjunction with FIGS. 6-8, an output queue of a designated port module 28 can correspond to a variety of different variables.

In particular embodiments, a port module 28 includes a memory structure that can include one or more linked lists that port module 28 can use, along with one or more registers, to determine a next packet to read from stream memory 30. The memory structure includes multiple entries, at least some of which each correspond to a block 38 of stream memory 30. Each block 38 of stream memory 30 has a corresponding entry in the memory structure. An entry in the memory structure can include a pointer to another entry in the memory structure, resulting in a linked list. A port module 28 also includes one or more registers that port module 28 can also use to determine a next packet to read from stream memory 30. A register includes a read pointer, a write pointer, and an offset. The read pointer can point to a first block 38 to which a first packet has been written, the write pointer can point to a first block 38 to which a second packet (which could be the same packet as or a packet other than the first packet) has been written, and the offset can indicate a first word 40 to which the second packet has been written. Because entries in the memory structure each correspond to a block 38 of stream memory 30, a pointer that points to a block 38 also points to an entry in the memory structure.

Port module 28 can use the read pointer to determine a next packet to read from stream memory 30 (corresponding to the “first” packet above). Port module 28 can use the write pointer to determine a next entry in the memory structure to which to write an offset. Port module 28 can use the offset to determine a word 40 of a block 38 at which to start reading from block 38, as described further below. Port module 28 can also use the read pointer and the write pointer to determine whether more than one packet is in the output queue. If output queue is not empty and the write pointer and the read pointer both point to the same block 38, there is only one packet in the output queue. If there is only one packet in the output queue, port module 28 can determine a next packet to read from stream memory 30 and read the next packet from stream memory 30 without accessing the memory structure.

If a first packet is added to the output queue when there are no packets in the output queue, (1) the write pointer in the register is modified to point to a first block 38 to which the first packet has been written, (2) the offset is modified to indicate a first word 40 to which the first packet has been written, and (3) the read pointer is also modified to point to first block 38 to which the first packet has been written. If a second packet is added to the output queue before port module 28 reads the first packet from stream memory 30, (1) the write pointer is modified to point to a first block 38 to which the second packet has been written, (2) the offset is written to a first entry in the memory structure corresponding to first block 38 to which the first packet has been written and then modified to indicate a first word 40 to which the second packet has been written, and (3) a pointer in the first entry is modified to point to first block 38 to which the second packet has been written. The read pointer is left unchanged such that, after the second packet is added to the output queue, the read pointer still points to first block 38 to which the first packet has been written. As described more fully below, the read pointer is changed when port module 28 reads a packet in the output queue from stream memory 30. If a third packet is added to the output queue before port module 28 reads the first packet and the second packet from stream memory 30, (1) the write pointer is modified to point to a first block 38 to which the third packet has been written, (2) the offset is written to a second entry in the memory structure corresponding to first block 38 to which the second packet has been written and modified to indicate a first word 40 to which the third packet has been written, and (3) a pointer in the second entry is modified to point to first block 38 to which the third packet has been written. The read pointer is again left unchanged such that, after the third packet is added to the output queue, the read pointer still points to first block 38 to which the first packet has been written. Port module 28 can use the output queue to determine a next packet to read from stream memory 30.

If a port module 28 includes more than one output queue, an algorithm can be used for arbitration among the output queues. Arbitration among multiple output queues can include determining a next output queue to use to determine a next packet to read from stream memory 30. Arbitration among multiple output queues can also include determining how many packets in a first output queue to read from stream memory 30 before using a second output queue to determine a next packet to read from stream memory 30. The present invention contemplates any suitable algorithm for arbitration among multiple output queues. As an example and not by way of limitation, according to an algorithm for arbitration among multiple output queues of a port module 28, port module 28 accesses output queues that are not empty in a series of rounds. In a round, port module 28 successively accesses the output queues in a predetermined order and, when port module 28 accesses an output queue, reads one or more packets in the output queue from stream memory 30. The number of packets that port module 28 reads from an output queue in a round can be the same as or different from the number of packets that port module 28 reads from each of one or more other output queues of port module 28 in the same round. In particular embodiments, the number of packets that can be read from an output queue in a round is based on a quantum value that defines an amount of data according to which more packets can be read from the output queue if smaller packets are in the output queue and fewer packets can be read from the output queue if larger packets are in the output queue, which can facilitate fair sharing of an output link of port module 28.

In many typical switches, output queues correspond only to a level of quality of service (QoS). In other words, each output port of the switch may have a separate queue for each QoS level. QoS can encompass rate of transmission, rate of error, or other aspect of the communication of packets through switch core 26, and reference to QoS can include class of service (CoS) or other traffic prioritization schemes, where appropriate. In other switches, output queues correspond to a combination of a level of quality of service (QoS) and an input port module 28 that received the packet. In other words, each output port may have a separate queue for each unique combination of input port number and QoS level.

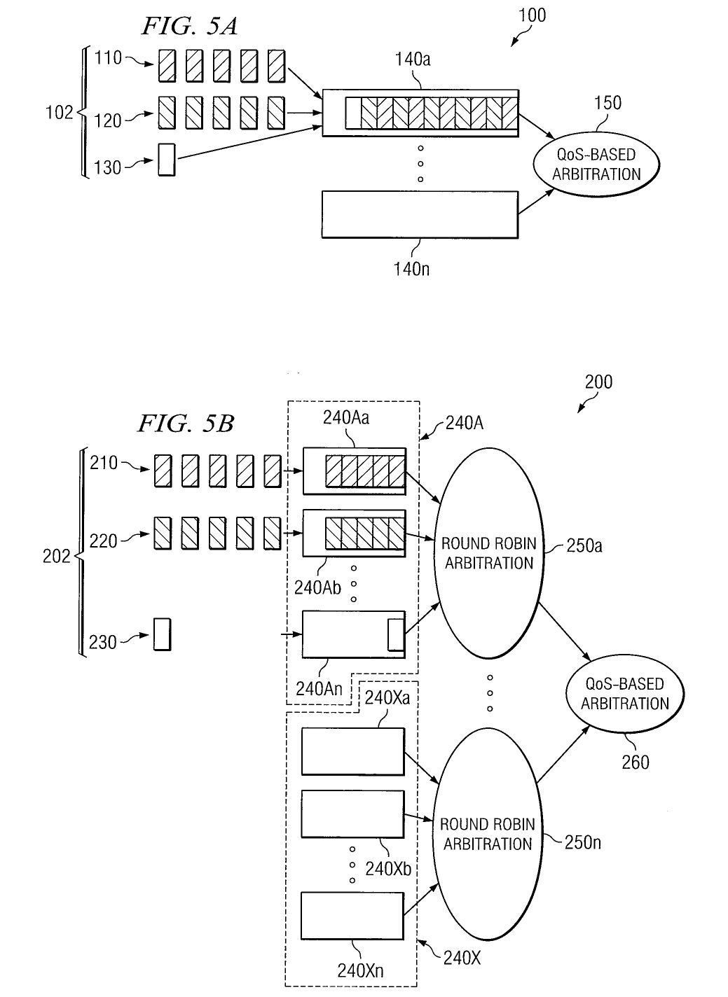

FIGS. 5A and 5B illustrate example output queue structures 100 and 200. In FIG. 5A, example queue structure 100, which may reside in a particular output port module 28, comprises a plurality of queues 140 that correspond only to the QoS level or class of incoming packets. Thus, pointers 102 to packets of the same QoS level are placed in the same QoS queue 140a, regardless of the input port module 28 at which their associated packets were received. For example, packets associated with pointers 110 may have been received at a first input port module 28, packets associated with pointers 120 may have been received at a second input port module 28, and the packet associated with pointer 130 may have been received at a third input port module 28. Queue structure 100 does not differentiate based on input port module 28, and thus places pointers 102 of packets having the same QoS level in queue 140a. QoS-based arbitration 150 may then be applied to the pointers in QoS queues 140 to select one of their associated packets for transmission. As is illustrated, there may be circumstances where the pointers 110 and 120 associated with packets received at two input port modules 28 dominate the queue, delaying transmission of the packet received at a third input port module 28 and associated with pointer 130. If the rate of packet transmission from each input port for the same class should be similar, that particular input port modules 28 can dominate a queue is inefficient and unfair.

It should be noted that references made in the discussion below to “packets” being in a particular queue or being selected from a particular queue are made for the sake of simplicity only. What is in or selected from a particular queue may, for example, be pointers to packets stored in blocks of stream memory 30 or other suitable identifiers, and not the packets themselves. Additionally, it should be noted that references made to queues corresponding to “input ports” are made for the sake of simplicity only. In these cases, queues may actually correspond to the port modules 28 associated with the input ports or a combination of ports and associated port modules 38, as appropriate, and not necessarily to the ports themselves.

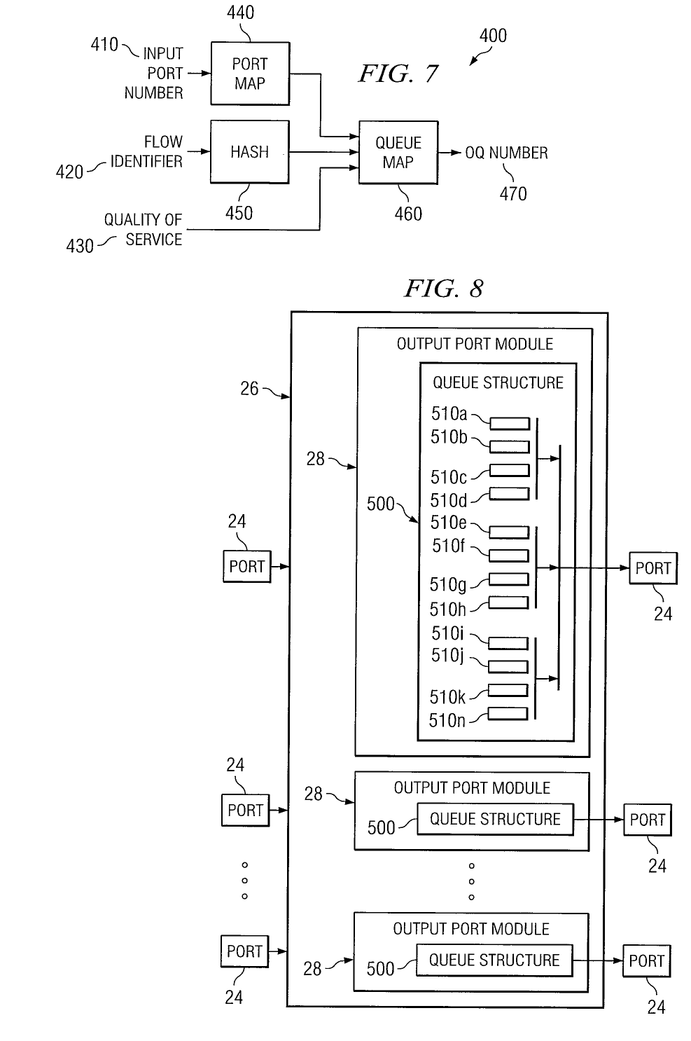

In FIG. 5B, example queue structure 200, which may reside in a particular output port module 28, comprises a plurality of queue sets 240A-240X that may correspond to the QoS of incoming packets. For example, all queues in set 240A may be associated with the same QoS level or class. Within each queue set are queues that can be associated with one or more particular variables, such as, for example, logical input ports, physical input ports, partitions, or other flow identifiers. These variables are discussed further below in conjunction with FIGS. 7 and 8.

For the sake of simplicity and to contrast structure 200 with structure 100, assume that the queues in a queue set, one of 240A-240X, correspond to particular physical input ports, as is the case in some typical switches. In other words, assume that packets are placed in the set of queues corresponding to their QoS and in the particular queue within that set that corresponds to the input port that received the packet. For example, assuming packets 210, packets 220, and packet 230 were received at different input ports, they may be placed in queues 240Aa, 240Ab, and 240An, respectively. Round-robin arbitration 250a may be applied to the next packet in each queue, 240Aa-240An, allowing packets from each input port module 28 to be transmitted equally for each QoS level or class. QoS-based arbitration 260 may then be applied to the packets selected using round-robin arbitration from sets 240A-240X, and a packet may be selected for transmission. Using QoS and input port variables to queue, structure 200 can queue packets more fairly and efficiently than structure 100 of FIG. 5A, as assessed by the goal of providing similar rates of transmission for each input port per class of service.

Although using QoS and input port variables to queue can lead to greater fairness and efficiency in some cases, in other cases, where, for example, network transmission goals are different, it may be fairer and more efficient for queue structure 200 to consider other variables in queuing packets. These other variables may track transmission goals more closely. For example, when link aggregation is used in a network, multiple transmission paths may be used in parallel between network devices in order to increase transmission speed. Packets received at two or more input port modules 28 in a switch 22 may thus correspond to only one source device. Treating packets that correspond to only one source device as one flow, instead of two separate flows, for queuing purposes may be a network transmission goal. Thus, a queue structure having queues that only correspond to QoS and physical input port may not deliver fair and efficient results, giving too much preference to packets received at different physical input port from the same source device. A queue structure 200 having queues corresponding to the source device, rather than or in addition to the physical input port, would provide fairer and more efficient results. Mapping packets to a source device and not to physical ports may be referred to as mapping the flows to a “logical” input port (as opposed to a physical input port). Where particular physical ports are reserved for a particular link aggregation, the actual physical ports may be mapped to a logical input port since the packets received at these physical input ports are associated with the link aggregation.

FIG. 6 is a block diagram illustrating example logic 300 for mapping physical input ports to a logical input port. Logic 300 may be executed, for example, in a network switch that has two or more input ports dedicated to link aggregation. Any part or parts of the switch may execute logic 300. For example, logic 300 may be executed in an output port module 28. In alternative embodiments, logic may be executed centrally, such as, for example, at central agent 34 or routing module 36. In alternative embodiments, particular steps of logic 300 may be executed in some locations and other steps may be executed in other locations in a switch.

In particular embodiments, in the first step of example logic 300, an incoming packet is received at a particular input port module 28 of switch 22. Input port module 28 may then store the packet in stream memory and send header and other suitable information associated with the packet to routing module 36 for suitable routing of the packet. Routing module 36 may forward this information to designated output port modules 28. After receiving this packet information, a designated output port module 28 may identify the input port module 28 that received the particular packet. Designated output port module 28 may identify, for example, an input port number 310. After identifying the input port module 28 for the particular packet, output port module 28 may use an output queue mapping table 320 and a selector 330 to map the input port for the packet to a logical port for the packet. In particular embodiments, output queue mapping table 320 and selector 330 may both reside at designated output port module 28. In alternative embodiments, table 320 and selector 330 may reside in any other suitable location of switch 22, and logic 300 may also be executed in other suitable parts of switch 22 besides output port module 28.

After receiving input port information, selector 330 may search for the input port in mapping table 320, the input port designated as “1-N” in the illustrated example logic 300. After finding the input port in table 320, selector may use mapping table 320 to identify a logical input port, designated as one of “A-Z,” associated with the input port and forward this information. Output port module 28 may use this information to queue the packet based at least in part on input logical port information. In networks using link aggregation, queues may thus correspond to logical input ports and not necessarily to physical input ports, a more efficient and fair result in particular cases. It should be noted that references made to “input ports” being found in mapping table 320 are made for the sake of simplicity only. In these cases, the input port modules 28 associated with the input ports may actually be what are found on mapping table 320, and not necessarily the ports themselves.

Under different circumstances, fairness and efficiency in transmitting packets may be assessed differently, demanding that the queues in queue structure 200 correspond to a different set of variables. For example, in a partitioned switch in a partitioned network, queues in queue structure 200 may correspond to these partitions. A partitioned network refers to a logically subdivided network, such as a virtual local area network (VLAN). In such a network, some network components may be included in one logical partition and other network components may be included in another logical partition. In particular cases, some network components may be included in more than one logical partition. A partitioned switch in a partitioned network refers to a switch operable to receive flows from two or more partitions. Particular switch input ports may be dedicated to particular partitions (such as, for example, particular VLANs) in some example partitioned switches. Additionally or alternatively, particular ports may be shared by one or more partitions. In a partitioned switch, a queue structure 200 having queues that correspond, at least in part, to network partitions may provide fair and efficient transmission results, if, for example, it is desirable to treat traffic in different partitions to equally.

As there may be more than one network transmission goal at one time or over time, such as considering link aggregation or network partitions, it is desirable for queue structure 200 to have queues that can correspond to variables associated with different network goals. In this way, queuing can be performed in a fair and efficient way according to these one or more network goals.

FIG. 7 is a block diagram illustrating example logic 400 for assigning packets to output queues. Logic 400 may be executed in a switch in any suitable network and may provide fair and efficient transmission results in networks using link aggregation and/or in partitioned networks. Any part or parts of the switch may execute logic 300. For example, logic 300 may be executed in an output port module 28. In alternative embodiments, logic may be executed centrally, such as, for example, at central agent 34 or routing module 36. In alternative embodiments, particular steps of logic 300 may be executed in some locations and other steps may be executed in other locations in a switch.

In particular embodiments, in the first step of logic 400, an incoming packet is received at a particular input port module 28 of switch 22. Input port module 28 may then store the packet in stream memory and send header and other suitable information associated with the packet to routing module 36 for suitable routing of the packet. Routing module 36 may forward this information to designated output port modules 28. This information may include, for example, three pieces of information: the input port for the packet 410, one or more flow identifiers 420, described further below, and a QoS value for the packet 430. Destination output port module 28 may process this information, as described below, to assign a suitable queue for the packet. More generally, this information may correspond to three variables used by destination output port module 28 to assign a packet to a queue. It should be noted that references made to “input ports” as a variable are made for the sake of simplicity only. In these cases, the input port modules 28 associated with the input ports may actually be the variables, and not necessarily the ports themselves. Additionally, it should be noted again that any suitable part or parts of switch 22 (and not necessarily port module 28) may process the three variables to assign a packet to a queue.

As discussed above, destination output port module 28 (or any other suitable part or parts of switch 22) may process three types of information: input port information 410, flow identifier information 420, and QoS information 430. It should be noted that, in particular embodiments, one or more of the three variables can be disabled. Disabling or enabling a variable may allow network operators to configure the switch to adapt to changing network goals. Thus, for example, if plans to use link aggregation in the network exist, network operators may enable the input port variable (specifically, the logical input port variable), allowing output queues to reflect the changing network goal. As another example, if plans to stop supporting partitions in the network exist, the flow identifier variable may be disabled, again allowing the output queues to reflect the changing network goals. More generally, packet variables may be enabled and disabled based, for example, on network transmission needs.

Destination output port module 28 (or any other suitable part or parts of switch 22) may process input port information 410 for the packet (assuming this variable is enabled) by mapping the input port to a logical port, as discussed above in conjunction with FIG. 6. In the illustrated embodiment, port map module 440 is used for mapping input port information to a logical port. For example, port map module 440 may comprise mapping table 320 and selector 330. If a particular input port module 28 is not associated with a logical port, map 440 may output any suitable value of a suitable size identifying the input port module 28. In alternative embodiments, map 440 may not be used (or exist) and input port information 410 may be sent directly to queue map module 460, described further below. In other embodiments, the logical or physical input port may not be used.

Destination output port module 28 (or any other suitable part or parts of switch 22) may also process flow identifier information 420 by sending it to hash function module 450. Flow identifier information 420 may comprise any suitable flow identifier, such as, for example, a packet source address, a packet destination address, a source port for the packet, a destination port for the packet, and/or a VLAN ID associated with the packet. As described above, one purpose of considering flow identifier information 420 in assigning packets to queues may be to identify more specific packet flows. As described above, queuing packets based on VLAN, an example flow identifier corresponding to a particular packet flow, may be part of a network transmission goal. However, any other suitable packet flows corresponding to any other suitable flow identifier or combination of flow identifiers may be identified.

It should be noted that although some packets associated with a VLAN may include a VLAN ID, other packets associated with the VLAN may not include a VLAN ID. Packets associated with a VLAN that do not include a VLAN ID may be identified as being associated with the VLAN by the input port through which they are received by a switch if the input port comprises a port VLAN ID. In other words, packets with no VLAN ID arriving at a particular input port may be associated, by default, with the VLAN associated with the input port. Queue map 460 may thus use the input port numbers 410 associated with packets to separate VLANs into particular queues (and need not use hash 450 to separate VLANs into particular queues).

In particular embodiments, the flow identifier information 420 in one or more of the fields described above may be sent to hash function module 450. Hash function module 450 may process the information that it receives in each field to generate a contribution value for each field. In particular embodiments, hash function module 450 may apply any suitable hash function, such as, for example, a randomization function, to each field to generate contribution values. A randomization function may randomize the information in each field and select particular bits from the randomized information as an output of the randomization function for the particular field. In particular embodiments, hash function module 450 may apply a CRC-8 function (X8+X6+X5+X+1) to the information in each field to create contribution values for each field. In particular embodiments, contribution values may be enabled or disabled. In these embodiments, those contribution values that are enabled may be XOR-ed together, or processed in any other suitable manner, to generate a hash value. This hash value may then be passed to queue map module 460 by hash function module 450. It should be noted that flow identifier information 420 may be processed in any suitable manner to generate a value associated with flow identifier information 420. This value may generally be referred to as a flow value.

One purpose of hash function module 450 may be to generate a hash value/hash result for each flow (depending on the flow identifier variables whose contribution values have been enabled). The hash value for each flow may then be used by queue map module 460 to assign a particular queue to a particular flow. Queues may thus correspond to flows, satisfying transmission goals in particular circumstances.

Another purpose of hash function module 450 may be to standardize the size of information considered from each field so that this information may be suitably processed by hash function module 450 and queue map module 460. To illustrate, VLAN identifiers are typically twelve bits, source or destination addresses of Ethernet data link layer are typically forty-eight bits, source or destination IP addresses are typically thirty-two bits in IPv4 and one hundred and twenty-eight bits in IPv6, and source or destination port identifiers are typically sixteen bits. To XOR these fields or otherwise suitably process them, hash function module 450 may randomize each field and select particular bits from each field to generate a contribution value for each field of a standard size (such as, for example, of eight bits). These values may then be suitably processed to create a hash value. The suitably sized hash value may then be suitably processed by queue map module 460.

Destination output port module 28 (or any other suitable part or parts of switch 22) may also process QoS information 420. QoS information may comprise any suitable QoS levels or other prioritizations associated with the packet being queued. This QoS information may be sent directly to queue map module 460 in particular embodiments.

The output from module 440, the output from hash function module 450, and/or the QoS information are sent to module 460. In particular embodiments, module 460 may receive and/or process only those inputs that are enabled. In particular embodiments, inputs may be enabled or disabled directly at the switch or using network management software. Thus, queue map module 460 can use any one of the three inputs or any combination of two or more of the inputs to generate an output queue number 470. In particular embodiments, output queue number 470 may be eight bits. Output queue identifier 470 may correspond to a particular output queue in the output queue structure of an output port module 28. Output port module 28 may then place the packet in the particular output queue. If another part of switch 22, such as, for example, central agent 34, is executing logic 400, output port module 28 may receive information from this part of the switch indicating the output queue in which to place the packet.

In particular embodiments, output queues are identified only by output queue identifier 470 and thus are reconfigurable to receive packets of different flows depending on the result of queue map module 460 (which depends on the inputs enabled). In this way, queuing can be configured to correspond to partitions and/or logical input ports and/or QoS. Queuing can also be configured to correspond to physical input ports and QoS, as is done in some typical switches, as described above.

FIG. 8 illustrates an example output queue structure 500 of an output port module 28 in a switch 26. As illustrated, an output queue structure 500 may reside in each output port module 28, and an output queue structure 500 may comprise any suitable number of output queues 510. In particular embodiments, limited resources in switch core 26 may limit the number of output queues 510 in each output queue structure 500 to a set amount.

Each output queue 510 in an output queue structure 500 may correspond to an output queue identifier 470 generated by queue map module 460. Thus, each output queue 510 may be configurable to receive different types of packet flows, depending on how queue map module 460 assigns an output queue identifier 470 to particular input values. For example, when particular input values are enabled, queue map module 460 may assign a particular output queue identifier 470 (and thus a particular queue) to a particular flow. When other particular input values are enabled, queue map module 460 may assign the same particular output queue identifier 470 (and corresponding queue) to another type of flow. This may especially be the case when the number of output queues is set, due to limited resources, for example, and there is a change in network transmission preferences, resulting in a change in enabled inputs to queue map module 460. In such a case, queues 510 may be reconfigurable to receive new types of flows.

Where the number of output queues 510 is set, queue map module 460 may, in particular embodiments, be constrained to consider only a suitable number of input values such that no more output queue identifiers 470 are generated than there are output queues. Thus, where there are twenty queues 510 per structure 500, it may be useless in particular embodiments for queue map module 460 to separate packets into twenty-five different types of flows. However, fully utilizing the twenty queues 510 may be efficient in particular embodiments, and it may be inefficient for queue map module 460 to generate substantially less output queue identifiers 470 than there are queues 510 in these embodiments. As described above, any suitable number and type of arbitration schemes may be used in queue structure 500. After applying these arbitration schemes, a packet may be selected and transmitted from output port 24.

Using the example queue logic and structure described above, a network operator can configure output port modules 28 to queue information in a number of different ways. For example, in a network using link aggregation but not partitioning, a network operator may enable input port variable 410 and port map module 440, disable flow identifier variable 420 (or the output of hash function module 450), and enable QoS variable 430 in order to satisfy network transmission goals. In this example situation, queue map module 460 could use these two input variables to identify a particular output queue in which to place the packet. For example, a particular output queue could correspond to each unique combination of logical port and QoS level. In a partitioned network using link aggregation, a network operator can enable, for example, all three variables to satisfy network transmission goals. For example, a particular output queue could correspond to each unique combination of logical port, partition, and QoS level. In a partitioned network using link aggregation where partitions are associated with physical input ports (and not necessarily flow identifiers), a network operator can enable input port variable 410, port map module 440, and QoS variable 430, and optionally disable flow identifier variable 420 (or the output of hash function module 450). For example, a particular output queue could correspond to each unique combination of logical port, input port (associated with a partition), and QoS level. Alternatively, a particular output queue could correspond to each unique combination of logical port and QoS level, if particular logical ports are associated with particular partitions. In a network using link aggregation but not partitioning or queuing based on QoS level, such as, for example, in a network using committed information rates (CIR), a network operator can enable input port variable 410 and port map module 440 and disable flow identifier variable 420 (or the output of hash function module 450) and QoS variable 430 to satisfy network transmission goals. For example, a particular output queue could correspond to each unique logical port. In a partitioned network that also queues based on QoS level, a network operator can enable flow identifier variable 420, hash function module 450, and QoS variable 430, and disable input port variable 410 (or the output of port map module 440) to satisfy network transmission goals. For example, a particular output queue could correspond to each unique combination of partition and QoS level. Alternatively, in a partitioned network where partitions are associated with physical input ports of a switch (and not necessarily with flow identifiers for at least some packets), a network operator can enable input port variable 410 and QoS variable 430, disable port map module 440, and optionally enable flow identifier variable 420 and hash function module 450 (if flow identifiers 420 of some packets are used to identify partitions). As can be observed, operators can enable and disable the three variables in any suitable number of combinations (within the constraints, if any, imposed by the number of output queues 510 available in output queue structure 500) to satisfy network transmission goals and needs.

Modifications, additions, or omissions may be made to the systems and methods described without departing from the scope of the disclosure. The components of the systems and methods described may be integrated or separated according to particular needs. Moreover, the operations of the systems and methods described may be performed by more, fewer, or other components without departing from the scope of the present disclosure.

Although the present disclosure has been described with several embodiments, sundry changes, substitutions, variations, alterations, and modifications can be suggested to one skilled in the art, and it is intended that the disclosure encompass all such changes, substitutions, variations, alterations, and modifications falling within the spirit and scope of the appended claims.

What is claimed is:

1. A method for assigning packets to output queues of a switch, comprising:
receiving a packet at an input port of a switch, the packet associated with a quality of service (QoS) value and at least one flow identifier, the flow identifier identifying a flow with which the packet is associated;
mapping the input port at which the packet was received to a logical input port;
processing the at least one flow identifier to generate a flow value; and
based at least on the QoS value, the flow value, and the mapped logical input port, assigning the packet to an output queue associated with an output port of the switch.

2. The method of claim 1, wherein the flow is associated with a partition of a network.

3. The method of claim 1, wherein mapping the input port at which the packet was received to a logical input port comprises using a table to look up a logical input port associated with the input port.

4. The method of claim 1, wherein logical input ports are associated with physical input ports based on a link aggregation scheme.

5. The method of claim 1, wherein processing the at least one flow identifier to generate a flow value comprises:
applying a hash function to the at least one flow identifier to generate a contribution value for each flow identifier; and
based at least in part on the contribution values, producing a hash value, wherein the hash value is the flow value.

6. A method for assigning packets to output queues of a switch, comprising:
receiving a packet at an input port of a switch, the packet associated with at least one flow identifier, the flow identifier identifying a flow with which the packet is associated;
processing the at least one flow identifier to generate a flow value; and
based at least on the flow value, assigning the packet to an output queue associated with an output port of the switch.

7. The method of claim 6, wherein the flow is associated with a partition of a network.

8. The method of claim 6, wherein processing the at least one flow identifier to generate a flow value comprises:
applying a hash function to the at least one flow identifier to generate a contribution value for each flow identifier; and
based at least in part on the contribution values, producing a hash value, wherein the hash value is the flow value.

9. The method of claim 6, wherein:
the packet is further associated with a quality of service (QoS) value; and
assigning the packet to the output queue is further based on the QoS value.

10. The method of claim 6, wherein assigning the packet to the output queue is further based on information associated with the input port.

11. A method for assigning packets to output queues, comprising:
receiving a packet at an input port of a switch;
mapping the input port at which the packet was received to a logical input port; and
based at least on the mapped logical input port, assigning the packet to an output queue associated with an output port of the switch.

12. The method of claim 11, wherein:
the packet is associated with a quality of service (QoS) value; and
assigning the packet to the output queue is further based on the QoS value.

13. The method of claim 11, wherein the packet is associated with at least one flow identifier, the flow identifier identifying a flow with which the packet is associated, further comprising processing the at least one flow identifier to generate a flow value, wherein assigning the packet to the output queue is further based on the flow value.

14. The method of claim 13, wherein the flow is associated with a partition of a network.

15. The method of claim 13, wherein processing the at least one flow identifier to generate a flow value comprises:
applying a hash function to the at least one flow identifier to generate a contribution value for each flow identifier; and
based at least in part on the contribution values, producing a hash value, wherein the hash value is the flow value.

16. A method for assigning packets to output queues, comprising:
establishing reconfigurable output queues associated with an output port of a switch;
receiving a packet at an input port of the switch;
based on first information associated with the packet, assigning the packet to one of the reconfigurable output queues; and
reconfiguring the output queues to receive packets at least based on second information associated with the packets.

17. The method of claim 16, wherein establishing reconfigurable output queues comprises assigning particular output queues to receive particular packet flows based on variables that can be enabled or disabled, the variables associated with the packet flows.

18. The method of claim 17, wherein reconfiguring the output queues comprises enabling a different set of variables.

19. The method of claim 16, wherein the first information is associated with at least one of the input port, a logical input port, a quality of service (QoS) value, and a partition of a network.

20. Logic encoded in a computer-readable medium, the logic operable when executed by a computer to:
receive a packet at an input port of a switch, the packet associated with a quality of service (QoS) value and at least one flow identifier, the flow identifier identifying a flow with which the packet is associated;
map the input port at which the packet was received to a logical input port;
process the at least one flow identifier to generate a flow value; and
based at least on the QoS value, the flow value, and the mapped logical input port, assign the packet to an output queue associated with an output port of the switch.

21. The logic of claim 20, wherein the flow is associated with a partition of a network.

22. The logic of claim 20, wherein mapping the input port at which the packet was received to a logical input port comprises using a table to look up a logical input port associated with the input port.

23. The logic of claim 20, wherein logical input ports are associated with physical input ports based on a link aggregation scheme.

24. The logic of claim 20, wherein processing the at least one flow identifier to generate a flow value comprises:
applying a hash function to the at least one flow identifier to generate a contribution value for each flow identifier; and
based at least in part on the contribution values, producing a hash value, wherein the hash value is the flow value.

25. Logic encoded in a computer-readable medium, the logic operable when executed by a computer to:
receive a packet at an input port of a switch, the packet associated with at least one flow identifier, the flow identifier identifying a flow with which the packet is associated;
process the at least one flow identifier to generate a flow value; and
based at least on the flow value, assign the packet to an output queue associated with an output port of the switch.

26. The logic of claim 25, wherein the flow is associated with a partition of a network.

27. The logic of claim 25, wherein processing the at least one flow identifier to generate a flow value comprises:
applying a hash function to the at least one flow identifier to generate a contribution value for each flow identifier; and
based at least in part on the contribution values, producing a hash value, wherein the hash value is the flow value.

28. The logic of claim 25, wherein:
the packet is further associated with a quality of service (QoS) value; and
assigning the packet to the output queue is further based on the QoS value.

29. The logic of claim 25, wherein assigning the packet to the output queue is further based on information associated with the input port.

30. Logic encoded in a computer-readable medium, the logic operable when executed by a computer to:
receive a packet at an input port of a switch;
map the input port at which the packet was received to a logical input port; and
based at least on the mapped logical input port, assign the packet to an output queue associated with an output port of the switch.

31. The logic of claim 30, wherein:
the packet is associated with a quality of service (QoS) value; and
assigning the packet to the output queue is further based on the QoS value.

32. The logic of claim 30, wherein the packet is associated with at least one flow identifier, the flow identifier identifying a flow with which the packet is associated, the logic further operable when executed to process the at least one flow identifier to generate a flow value, wherein assigning the packet to the output queue is further based on the flow value.

33. The logic of claim 32, wherein the flow is associated with a partition of a network.

34. The logic of claim 32, wherein processing the at least one flow identifier to generate a flow value comprises:
applying a hash function to the at least one flow identifier to generate a contribution value for each flow identifier; and
based at least in part on the contribution values, producing a hash value, wherein the hash value is the flow value.

35. Logic encoded in a computer-readable medium, the logic operable when executed by a computer to:
establish reconfigurable output queues associated with an output port of a switch;
receive a packet at an input port of the switch;
based on first information associated with the packet, assign the packet to one of the reconfigurable output queues; and
reconfigure the output queues to receive packets at least based on second information associated with the packets.

36. The logic of claim 35, wherein establishing reconfigurable output queues comprises assigning particular output queues to receive particular packet flows based on variables that can be enabled or disabled, the variables associated with the packet flows.

37. The logic of claim 36, wherein reconfiguring the output queues comprises enabling a different set of variables.

38. The logic of claim 35, wherein the first information is associated with at least one of the input port, a logical input port, a quality of service (QoS) value, and a partition of a network.
